(19) United States
(12) Patent Application Publication
(10) Pub. No.: US 2018/0211561 A1
(43) Pub. Date: Jul. 26, 2018

(54) Method and Process of Educating, Evaluating, and Certifying Commercial Drivers

(71) Applicant: Ronnie Jones, Deland, FL (US)

(72) Inventor: Ronnie Jones, Deland, FL (US)

(21) Appl. No.: 15/842,818

(22) Filed: Dec. 14, 2017

Related U.S. Application Data
(63) Continuation-in-part of application No. 14/751,045, filed on Jun. 25, 2015.
(60) Provisional application No. 61/998,333, filed on Jun. 25, 2014.

(51) Int. Cl. G09B 19/16; G09B 19/14; G06Q 10/06; G09B 19/18; G09B 9/052; G09B 9/042; G06Q 50/30

(52) U.S. Cl. CPC G09B 19/167; G09B 19/14; G06Q 10/06398; G06Q 50/30; G09B 9/052; G09B 9/042; G09B 19/18

(57) ABSTRACT

The present invention is a method and process for educating, training, retraining, evaluating, testing, and certifying commercial truck drivers as certified trans-contractors, equipped with the knowledge and skills required by the industry to yield competent, safe, and successful drivers, helping to make the industry and the roads safer for all travelers. A 15-step process is described, which when followed, produces a certified trans-contractor equipped with the knowledge and tool set required to be a successful and competent commercial truck driver. A companion mobile device application, the Trans-contractor app, is configured to assist the candidate throughout the process, and equip the graduated Trans-contractor with industry tools designed to facilitate a successful career in the commercial transportation industry.

### CONTINUITY

This application is a Continuation-in-Part of non-provisional application Ser. No. 14/751,045, filed on Jun. 25, 2015, which claims priority to provisional patent application No. 61/998,333, filed on Jun. 25, 2014, and priority is claimed thereto.

### FIELD OF THE PRESENT INVENTION

The present invention relates to commercial driver evaluation and certification, and more specifically relates to the process of educating and certifying individuals in safe and healthy commercial trucking practices to ensure quality work and road safety are achieved via a comprehensive mobile device application.

### BACKGROUND OF THE PRESENT INVENTION

Commercial drivers currently contribute to a large number of accidents, injuries and fatalities on American roads. Presently, there are no retraining programs on entry level commercial trucking programs. Unfortunately, Professional Truck Driver Institute (P.T.D.I) standard programs are left to the companies or employers to enforce participation and ensure drivers receive ongoing training, which is rarely offered. Companies' lack in participation in retraining commercial drivers reflects the high number of accidents and driver turn over rate present in the commercial trucking industry today. Currently the standards set by P.T.D.I do not offer studies in accounting, marketing, hygiene, mental wellness, accountability, self motivation and C.V.E Training. Additionally, there currently are no refresher courses available to retrain commercial drivers in these areas.

As the unemployment rate remains high, undertrained commercial drivers contribute to the accidents, injuries and fatalities on American roads today. By introducing the certified “Trans-Contractor” to the industry, a conscientious and knowledgeable driving professional promoting safety and efficiency, while contributing to the reduction of road accidents and injuries caused by the under-trained commercial drivers of today. There is currently no criterion of exceptional, for commercial driver licensees above the entry-level standards established by Professional Truck Driver Institute. Unfortunately, the absence of a stream-lined negotiation process and a verifiable system ensuring driver proficiency detrimentally affects safety on the roadways, and contributes to delays of service, as well as accidents.

Thus, there is a need for a new commercial truck driver certification, education, and training system and platform configured to train, retrain, and produce competent, expert commercial truck drivers, making the roads safer for all drivers. There is a need for an outreach program and continued education initiative that can affect the trucking industry operations on a daily basis by reducing congestion, improving driver safety, and increasing employment across the trucking industry. Drivers that would participate in such a program are to be retrained as ambassadors of excellence in the field, and have an accomplishment via a certification to indicate that the driver has been trained to extemporaneously negotiate fair and equitable driving contracts with clients, use modern technology as a way to enhance and reinforce roadside safety enforcement practices for monitoring compliance and increasing industry safety. A need for a first fully functional commercial license continuing education curriculum and evaluation process is required. Similarly, there is a need for a self-contained platform that allows truck drivers (or soon-to-be truck drivers) to train and practice on a simulated bidding system, facilitated by a computer in communication with the platform. Such a system preferably employs a mobile device application, which facilitates the training, evaluation, tracking, and certifying of trans-contractors, and manages the creation of a website for the graduated trans-contractor to assist in the creation of an online public image for the trans-contractor.

### SUMMARY OF THE PRESENT INVENTION

This Summary of the Invention is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is a system and platform for training, evaluating, and qualifying commercial truck drivers. The platform is preferably embodied by a mobile device application, referenced as a trans-contractor ‘app.’ The method/process of the present invention, enacted via the trans-contractor app, qualifies a professional commercial driver to conduct individual contracting job opportunities directly with any clients in legal possession of a commercial vehicle. The initiative enacted by the present invention is to provide the first certification in the commercial transportation industry that produces and certifies expert drivers, and helps to guarantee an ongoing, successful career in the transportation industry. The method and process provides continued education services and certifications, helping to minimize the number of third and fourth party brokers, as well as to help to eliminate accidents, fatigue and delivery delays in the commercial transportation industry.

Candidates are first evaluated on their prior experience in the industry, including any past moving violations, background issues, work history, and other information. Preliminary testing is preferably administered to gauge the candidate's knowledge of the industry in order to best tailor the remainder of the program to teach the candidate appropriate material for the candidate's experience level. For example, the program of the present invention for a candidate that has little to no commercial driving experience would vary greatly from a program administered to a candidate that has extensive trucking or commercial driving experience. However, all of such training programs are preferably administered via the trans-contractor app.

The process of the present invention is configured to verify the aptitude of current commercial driver licensees in core competencies that are inclusive of, but not exclusive to accounting, marketing, hygiene, mental wellness, accountability, self-motivation, and Commercial Vehicle Enforcement training. Candidates must achieve a passing score on a test covering each section in order to proceed to the subsequent section.

The method/process establishes a reproducible system of aptitude authentication that is designed to improve the quality of the industry workforce, decrease accidents, injuries and fatalities and minimize intrinsic delays. The absence of a stream-lined negotiation process and a verifiable system ensuring driver proficiency detrimentally affects safety on the roadways and contributes to delays of services within the industry.

### BRIEF DESCRIPTION OF THE DRAWINGS

The present invention will be better understood with reference to the appended drawing sheet, wherein:

FIG. 1 is a flow chart depicting the preferred executed process of the present invention as it pertains to the instruction, education, and certification of commercial truck drivers.

FIG. 2 is a flow chart of the commercial trucking industry presently.

FIG. 3 is a flow chart of the commercial trucking industry after implementation of the Trans-contractor certification provided via the process of the present invention.

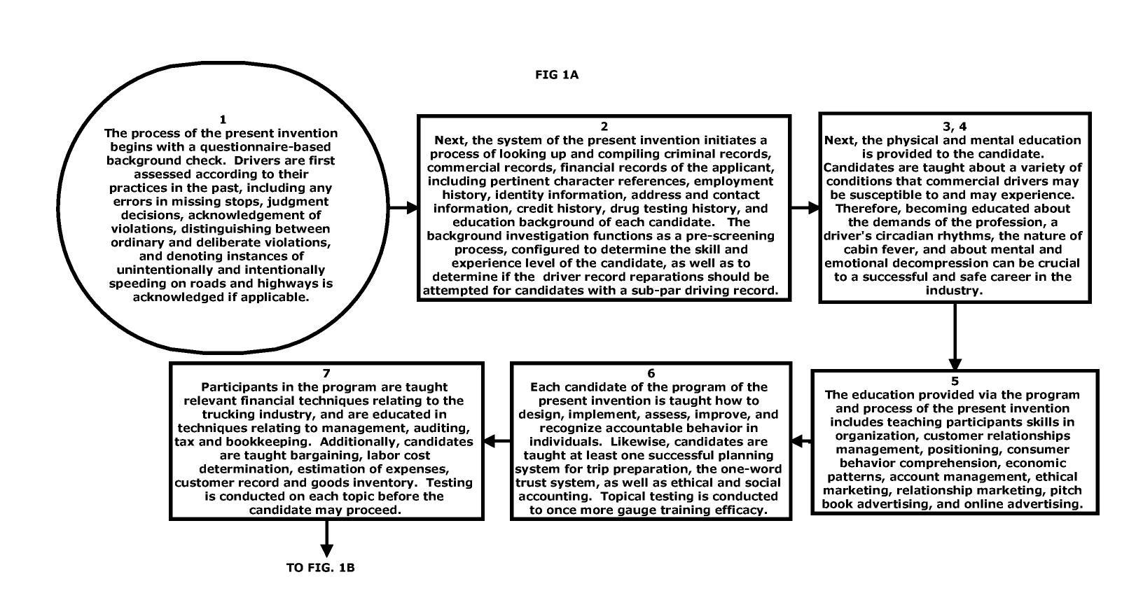

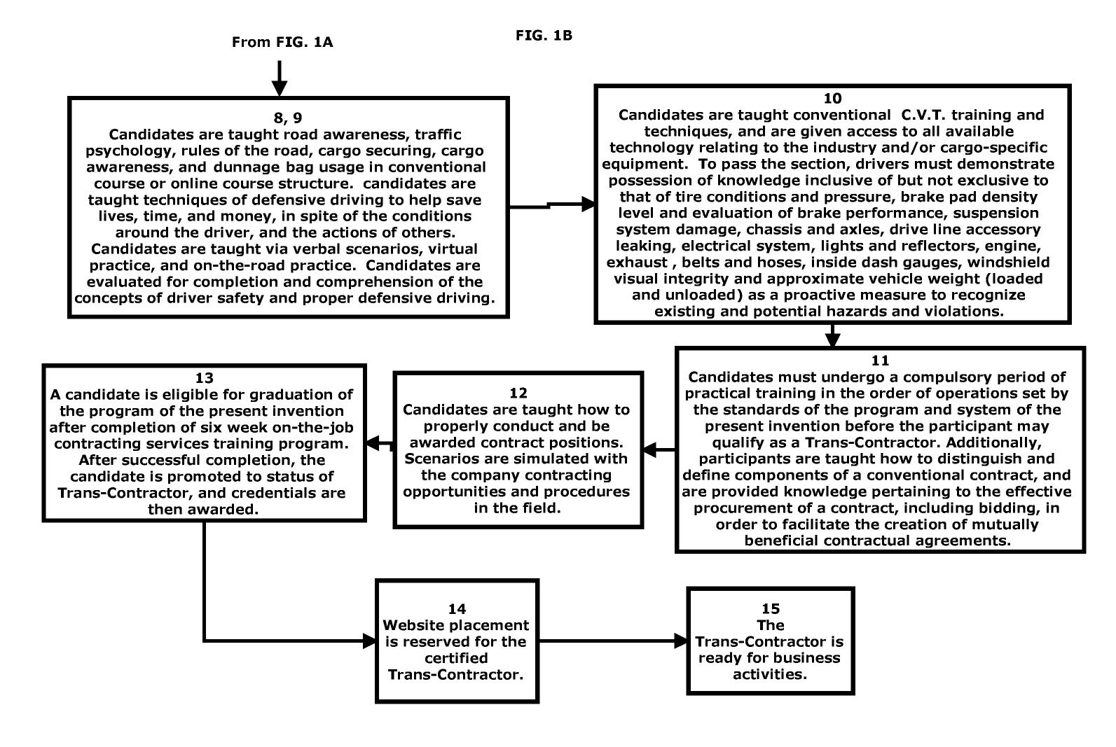

### DETAILED DESCRIPTION OF THE PRESENT INVENTION

There is currently a prevalence of under-trained drivers contributing to highway accidents, injuries, and fatalities, as well as an oversaturation of middlemen in the negotiation process. The present invention is a system, process, and platform that seeks to rectify this issue by providing a comprehensive education, training, evaluation, monitoring, and certifying commercial drivers to be a Trans-contractor. The robust system and method of the present invention is preferably accomplished via a trans-contractor app (10). There are 15 primary steps involved in the education, evaluation, and testing process of the present invention that produces a certified “Trans-Contractor” when completed. The steps are primarily enacted via the trans-contractor app (10), and preferably include:

1. Driver Screening

2. Evaluation/background,

3&4. Physical/Mental evaluation

5. Marketing Program

6. Accountability

7. Accounting

8 and 9. Driver Safety/Defensive Driving Training

10. Commercial Vehicle Enforcement Training

11. Contract Training

12. Graduate certification practicum

13. Graduation

14. Website Creation and Placement

15. Trans-Contractor activation status

A companion mobile device application, referred to as the Trans-contractor app (10), is configured to assist the candidate through the 15 steps of the process of the present invention, facilitating the monitoring, education, and progress of the candidate in real-time. The trans-contractor app (10) is designed to be in continued use by the graduated trans-contractor after completion of education/certification, facilitating contract placement via bidding systems, and personal business website management and creation. The Trans-contractor app (10) is preferably configured to run on a wide variety of mobile devices, including smartphones and tablets. Some embodiments of the trans-contractor app (10) may be configured to be used on conventional computers as well.

1. Driver Screening: In the interest of personal and public health and safety, the process of the present invention begins with a questionnaire-based background check, preferably administered via the trans-contractor app (10). The questionnaire-based background check is performed by the driver (program candidate), which may be conducted verbally, on a computer, or on paper. Drivers are first assessed according to their practices in the past, including any errors in missing stops, judgment decisions, acknowledgement of violations, distinguishing between ordinary and deliberate violations, and denoting instances of unintentionally and intentionally speeding on roads and highways is acknowledged if applicable. The background check is evaluated either automatically via the system of the present invention (via a link between the trans-contractor app (10) and a background-checking service) or may be personally reviewed by staff. The background check helps to call attention to any areas which may require additional education, instruction, and/or practice. Additionally, it serves as a security check for the industry, ensuring that the candidate continues to meet the minimum industry guidelines if they are already active in the industry.

It is crucial to determine the nature of the driver's background accurately, as the program of the present invention is configured to help drivers to remedy portions of their driving record if needed. As such, the trans-contractor app (10) provides training as it relates to the needs of the user. The record remediation process of the present invention provides drivers with the steps and tools to access, interpret, and repair information obtained from national reporting agencies i.e. Drive-A-Check (DAC) and state reporting agencies i.e. Pre-employment Screening Program (PSP) to ameliorate the effects of excessive violations, thus creating a pathway for reintroduction into the workforce. The current system relies on time for negative information to “fall off” of reports as the expense to dispute erroneous information can be cost prohibitive. The FMCSA 2015 data snapshot reports over 2 million roadside vehicle inspections with an Out-of-Service violation rate of 20%, representing nearly 500,000 Out-of-Service violations in 2014 alone. The 2013 edition of the annual BenchmarkPro Survey reports a turnover rate across all industries at 15.1%. The American Trucking Association 3rd Quarter truck driver turnover rate was reported at 97%.

2. Evaluation/Background Investigations—Next, the system of the present invention, via the trans-contractor app (10), initiates a process of looking up and compiling criminal records, commercial records, financial records of the applicant, including pertinent character references, employment history, identity information, address and contact information, credit history, drug testing history, and education background of each candidate. The background investigation functions as a pre-screening process, configured to determine the skill and experience level of the candidate, as well as to determine if the driver record reparations should be attempted for candidates with a sub-par driving record. To do so, it should be understood that the trans-contractor app (10) is running on a mobile device in communication with a network, including the internet, to facilitate connection to such records of interest.

3 & 4. Physical and Mental—aspects that are covered on mental demand, physical demand, temporal demand, overall performance, frustration level and effort level. Candidates are taught about a variety of conditions that commercial drivers may be susceptible to and may experience. Therefore, becoming educated about the demands of the profession (including long hours, the need to keep a good driving record, timeliness, requisite break periods on shift, etc), a driver's circadian rhythms (such as how the sleep cycle of a driver may effect his/her efficacy), the nature of cabin fever (including being alone in a cab for extended periods of time), and about mental and emotional decompression can be crucial to a successful and safe career in the industry. Candidates are tested at the end of each topical section, preferably in a written format in a classroom setting, or in some embodiments, via the trans-contractor app (10). Candidates attain a passing average score as compiled using the individual scores from each topical section test may continue to the next section of education. Candidates that fail to achieve a satisfactory average may opt to be placed on a list to repeat the classroom component in the future.

5. Marketing Program—The education provided via the program and process of the present invention includes teaching participants skills in organization, customer relationships management, positioning, consumer behavior comprehension, economic patterns, account management, ethical marketing, relationship marketing, pitch book advertising, and online advertising. These skills are taught to each trans-contractor candidate to help to ensure that each Trans-contractor certified driver is equipped with the skills to market and advertise his or her driving services competently and effectively, due in part through the assistance of the accreditation provided by the present invention. Motivation classes are also a portion of the program set forth in step five of the present invention, which includes education pertaining to: self-motivation, temporal motivation, achievement motivation, self determination theory, goal setting, models of behavior change, acceptance, curiosity, eating, family, honor, independence, physical activity, saving, vengeance, social contact, and tranquility. Testing is preferably performed in a written format, and is preferably conducted on information contained in each section or component, as presented in a classroom setting. Some embodiments may manage testing via the trans-contractor app (10), while remaining in a classroom setting. Candidates that achieve a passing average score as compiled with the individual scores of each component is eligible to participate in the subsequent Practicum portion of instruction.

6. Accountability—Each candidate of the program of the present invention is taught how to design, implement, assess, improve, and recognize accountable behavior in individuals. Likewise, candidates are taught at least one successful planning system for trip preparation, the one-word trust system, as well as ethical and social accounting. Topical testing is conducted to once more gauge training efficacy. Testing may be performed on or in concert with the Trans-contractor app (10), wherein the Trans-contractor app (10) may arrange questions and testing frequency based on responses from the candidate. In such cases, the Trans-contractor app (10) may be configured to administer the topical testing.

7. Accounting—Participants in the program are taught relevant financial techniques relating to the trucking industry, and are educated in techniques relating to management, auditing, tax and bookkeeping. For example, candidates are taught how to estimate quarterly tax obligation payments for non-payroll employees, effective record-keeping methods, and budgeting. Additionally, candidates are taught the skills of bargaining, labor cost determination, estimation of expenses, customer record and goods inventory. The importance of maintaining and keeping receipts and correct invoices is emphasized. Each of these skills is also evaluated with testing prior to completion of the classroom portion, before progressing to the practice training portion of step 8 and step 9. Similarly, testing on these topics may also be performed on or in concert with the Trans-contractor app (10), wherein the Trans-contractor app (10) may arrange questions and testing frequency based on responses from the candidate. In such cases, the Trans-contractor app (10) may be configured to administer the tests relating to these topics.

8 & 9. Driver Safety and Defensive Driving—In steps 8 and 9, the system of the present invention teaches road awareness, traffic psychology, rules of the road, cargo securing, cargo awareness, and dunnage bag usage in conventional course or online course structure. Additionally, candidates are taught techniques of defensive driving to help save lives, time, and money, in spite of the conditions around the driver, and the actions of others. Candidates are taught via verbal scenarios, virtual practice, and on-the-road practice. Candidates are evaluated for completion and comprehension of the concepts of driver safety and proper defensive driving.

10. Commercial Vehicle Enforcement (C.V.E) training—Candidates are taught conventional C.V.E. training and techniques, and are given access to all available technology relating to the industry and/or cargo-specific equipment. C.V.E training is provided to ensure the competent and confident ability to consistently perform Level I, II III IV, V and VI inspections properly. To do this, drivers must demonstrate possession of knowledge inclusive of but not exclusive to that of tire conditions and pressure, brake pad density level and evaluation of brake performance, suspension system damage, chassis and axles, drive line accessory leaking, electrical system, lights and reflectors, engine, exhaust, belts and hoses, inside dash gauges, windshield visual integrity and approximate vehicle weight (loaded and unloaded) as a proactive measure to recognize existing and potential hazards and violations.

Duties for the enforcement of regulations are divided among the Department of Transportation and the Department of Motor Vehicles. Pre-Trip checklists are typically required to be performed by drivers within 10-30 minutes while inspections performed on the road can take hours. All motor carriers that haul cargo in interstate commerce must be registered with the Federal Motor Carrier Safety Administration and must have a U.S. Department of Transportation number. 2.2 million Commercial motor vehicle drivers in 2013 were interstate operators, 900,000 held a commercial drivers license. Commercial Drivers License (CDL) endorsements are federally recognized but state issued.

Currently, most violations cited during roadside inspections are negatively reflected upon the record of the trucker. To further promote compliance and lessen the occurrence of violations, drivers will also have access to a downloadable application (app) that allows the driver to enter states entailed in a specified route. The app will list regulations particular to each state and in some cases highlight regulations deemed unique and to be of extra importance for driver regulatory compliance. This downloadable application may be incorporated into the trans-contractor app (10) of the present invention in some embodiments of the present invention.

The process of the present invention provides a systematic means to measure and improve the human skill component in an industry with historic and projected decreasing supplies of human capital. The process is driver-focused with the goal to quantify the necessary skills and subsequently improve the performance of the indispensable human element beyond the basic level. Critical components for measurement are identified and then quantified into values to facilitate standardization, and computer-based adaptive testing (via the trans-contractor app (10)) assures goals for excellence will be met by the certified trans-contractor. Prior solutions appear to have a focus that is not driver-centered. A reliance on technology improves equipment, but not the operator of the equipment. Increased regulations can lead to system improvements, but only if the operator is compliant. No one has applied objective quantitative values to the skills and knowledge of the driver. To date, there are over 30 years of studies of industry issues, and for the past 10 years, industry experts have compiled “problem” lists, but actual change to performance and processes within the trucking industry at large has been minimal.

Therefore, there has to be a systematic quantification of disparate components to obtain uniformity of applications within the process, or assessment and evaluation will be compromised, and the process will not work. All components of the training provided by the system of the present invention are critical. Assigning value along a fixed continuum is a critical step. The hierarchal relationships between components are subject to rearrangement, but have little bearing upon testing when utilizing a computer adaptive assessment program. The initial version of the Trans-Contractor methodology was not weighted respective of depth and scope within the trucking industry. The initial approach was designed to provide a pathway to solve the commercial driver shortage, a shortage of manpower in an industry where the high costs siphoned off by intermediaries are built into the system. The Trans-Contractor methodology, in its current form, offers a means by which business entities have an option to utilize the current system, or can confidently interface with a commercial driver licensee with a verified set of knowledge and skills through which interaction can reliably decrease expense elements paid throughout the process by streamlining the need for intermediaries.

11. Contract Training—Candidates to be a certified trans-contractor must undergo a compulsory period of practical training in the order of operations set by the standards of the program and system of the present invention before the participant may qualify as a Trans-Contractor. Additionally, participants are taught how to distinguish and define components of a conventional contract, and are provided knowledge pertaining to the effective procurement of a contract, including bidding, in order to facilitate the creation of mutually beneficial contractual agreements. As such, bidding simulations are preferably provided to the candidate via the trans-contractor app (10). Therefore, graduates of the program and system of the present invention may competently present terms and conditions of service for work, creating more equitable working conditions. This, in turn, causes a decrease in related job disillusionment, job dissatisfaction, and subsequent attrition.

12. Job Contracting—The candidate is taught how to properly conduct and be awarded contract positions. Scenarios are simulated with the company contracting opportunities and procedures in the field via a bidding simulation via the trans-contractor app (10).

13. Graduation—A candidate is eligible for graduation of the program of the present invention after completion of a six-week, on-the-job contracting services training program. After successful completion, the candidate is promoted to status of Trans-Contractor, and credentials are then awarded.

14. Website creation and placement is reserved for the certified Trans-Contractor, which is preferably unlocked within the trans-contractor app (10) upon verified completion of training. A computer server, in communication with the Trans-contractor app (10) on the mobile device of the certified Trans-contractor is preferably configured to reserve both a custom website domain name, as well as hosting space for the Trans-contractor. Basic settings for the website of the Trans-contractor may preferably be configured via the Trans-contractor app (10). In all embodiments of the customized website, it is envisioned that the following are included on the website: the name of the certified trans-contractor, type of equipment owned (if applicable), proficiency ratings (from one to ten) of driving each type of equipment (hazmat, flat bed, tanker, passenger, etc.) years of driving experience, driving history/records (including violations and/or infractions), and an efficiency (timeliness) rating. In some embodiments of the Trans-contractor app (10) of the present invention, it is envisioned that the Trans-contractor app (10) may automatically populate content based on information attained from the Trans-contractor's progress through the program, as well as any beneficial elements found within the initial background questionnaire. For example, if the certified Trans-contractor stated in step 1 that he or she had 10 years experience in the industry, and has had only minor moving violations, these elements may be automatically populated to his/her website via the computer server and Trans-contractor app (10) of the present invention. The Trans-contractor is encouraged to complete the setup of his or her website prior to beginning business activities.

Additionally, the website created for the trans-contractor is preferably configured to display the proficiency ratings of the certified trans-contractor as it relates to the driver's proficiency in use of specific equipment, including, but not limited to: flat bed trucks, haz-mat trucks, tanker trucks (dealing with surge), passenger vehicles (busses, coaches), etc.

15. Having completed the program, and a custom-made business website is now running, the Trans-Contractor is ready for business activities.

Each of these steps is vital in the procedure to produce a certified Trans-Contractor. Steps 1 through 4 evaluate the experience, physical and mental state of the applicant. Steps 5 through 7 test the candidate's ability to understand the aspects of financial decision making. Steps 8 through 11 introduce the candidate (participant) to the process of operation and procedures common to the industry. Steps 12 through 15 simulate the working environment of the industry in detail, preferably via the use of simulators, as well as on-the-road training and practice. The simulators employed are preferably facilitated on a computer, or may also be presented via the Trans-contractor app of the present invention. It is envisioned that steps 6 through 10 can be shuffled or interchanged to produce the same results. The end result, if the candidate meets the standards of the program of the present invention, is a graduation awarding the candidate the status and certification of a Trans-contractor, a ready-made website, and a fully unlocked trans-contractor app (10).

By increasing client confidence of selection providing a cohesive and strategy to garner industry respect by infusing the transportation market with skillful ambassadors of excellence and accomplishment that use relevant and meaningful language to extemporaneously negotiate fair and equitable contracts and define, measure, and increase the maximum utilization of resources safely. Additionally, by educating drivers to be good communicators, deal makers and self managers to the industry, drivers will be eager to go out on the road and tell their accomplished story. The certification provided via completion of the process of the present invention enables drivers to be able and willing to present a cohesive vision for success, and have a strategy to garner respect in the industry.

Graduates of the program of the present invention, called ‘trans-contractors’ are also taught how to use trans-contractor technologies, including but not limited to the unlocked version of the Trans-Contractor app (10), a mobile device application configured to assist the candidate as he or she progresses through the program of the present invention, as well as to help the graduated Trans-contractor to log clients, routes, track the driver and his/her driving habits, and truck load data. Similarly, the Trans-contractor app (10) may be used to refresh the trans-contractor's skills throughout his or her career at any time. The Trans-Contractor app (10) is designed to operate and improve the Trans Contractor's performance, and to provide a platform for running safe and efficient practices in Trans-Contractor driver and client functionality. The Trans-Contractor app (10) is configured to:
Display truck with load availability and destination;
Display truck with projected load pick up requirements;
Customer equipment operational experience and requirements;
Bid packet submission form and acceptance agreement;
Provide notifications and alerts on individual state law on commercial vehicle regulation and rules while traveling interstates;
Displays rest stop, truck stop, truck parking, weight stations, truck repair, truck friendly restaurants, traffic and weather;
Provide multiple routing scenarios and options;

Additionally, via the Trans-contractor app (10), drivers (certified/graduated trans-contractors)may perform a group of coordinated functions, tasks, or activities. These functions and activities include, but are not limited to:
Gross vehicle weight and commodity information logging.
Maintenance records, qualifications check list, and logging.
Repair and maintenance summary report.
Pre-trip inspection check list of commercial vehicles.
Interim inspection notification and check list.
Post trip check list.

Each of these activities are preferably practiced and simulated during steps 8 and 9 to ensure that the candidate knows how to properly use the Trans-contractor app (10), so that he or she may continue to use the unlocked version of the Trans-contractor app (10) after being certified as a trans-contractor, and working on contracts in the field.

These features are preferably contained within the proprietary Trans-contractor app (10), and may only be accessible to (unlocked for) certified trans-contractors that have been educated in the proper use of the Trans-contractor app (10). It should be understood that the Trans-contractor app (10) is configured to be used by candidates of the program of the present invention, and is to assist the candidate during the classroom portion of the program, as well as to help the candidate after graduation with a variety of common industry-based technologies listed above.

As the present invention employs a progressive testing system, the Trans-contractor app (10) functions in concert with the system of the present invention. The trans-contractor app (10) is configured to monitor the candidate's improvement as the candidate progresses through the classwork in the classroom portions of the program. The trans-contractor app (10) enables the candidate to track his or her progress in each section of the program in real-time, helping to motivate the candidate toward graduation. Once the candidate passes the classroom portion, the candidate may move on to the practical training portions of the program. However, if the candidate does not pass the classroom portions of the program of the present invention, the candidate must start the program over again from the beginning. Progress of the candidate's scores from tests towards graduation is provided to the candidate in real-time on the Trans-contractor app (10). The Trans-contractor app (10) is also configured to expedite the physical and mental evaluation of step 3 and step 4 with integrated psychiatric evaluation testing via prompts posited to the candidate on the Trans-contractor app (10).

Most importantly, use of the Trans-contractor app (10) continues after the Trans-contractor has exited the program as a certified Trans-contractor, enabling the Trans-contractor to employ all of the features of the Trans-contractor app (10) in a real industry setting, rather than a simulation, as the working (live) versions of these features are activated by the secured server upon verification that the trans-contractor has passed. For example, step 11 educates the candidate on the proper practices for bidding on contracts. These bids are simulated through the use of the Trans-contractor app (10), locked in a simulation mode. In some simulations of bidding, the Trans-contractor app (10) is in communication with a simulated email client, which is configured to interact with the candidate as though the candidate were interacting with an authentic client. The simulated email client is configured to receive emails from the candidate regarding bidding on a simulated contract. Upon receipt, the email client is preferably configured to send a simulated response to the candidate, simulating a contract bidding conversation.

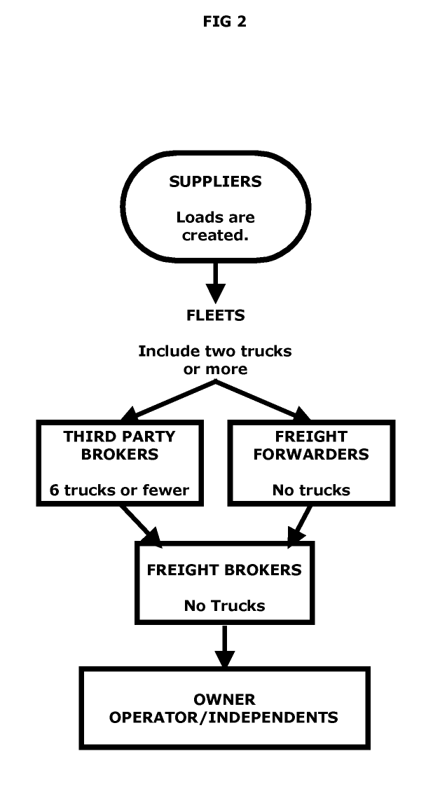

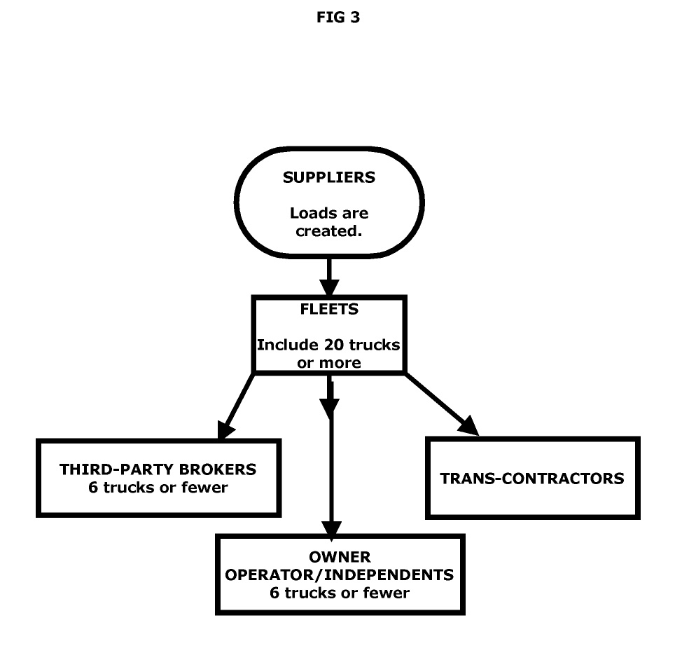

For reference, it should be noted that FIG. 2 displays the current industry architecture, detailing the flow of goods from suppliers through bidding contracts to fleets, third party brokers and freight forwarders, then to freight brokers, and finally to the trucks of owner-operator/independents. After implementation of the present invention into the commercial transportation industry, it is envisioned that the architecture would resemble that of FIG. 3. The primary difference being that fleets can potentially be composed directly of third-party brokers, owner-operators, and the newly created class of Trans-contractors.

It should be understood that the system of the present invention is preferably configured to create the website for the trans-contractor based on questions posed to the trans-contractor via the trans-contractor app (10). Additionally, it should be understood that the present invention preferably employs at least one computer to facilitate the simulation of bidding on jobs, allowing the user to practice before beginning actual work via bidding. Namely, the trans-contractor app (10) of the present invention is designed to simplify the user experience, both in educating the user (future trans-contractor), as well as facilitating the assignment of contracts to the graduated trans-contractor via a bidding process. Notable features of the trans-contractor app (10) include the ability to practice bidding, which is facilitated through a secured server computer so as to enable the trans-contractor to learn the process by which he or she will find work post-graduation. Additionally, work/contracts found can be assessed via the trans-contractor app (10), facilitating an all-encompassing solution for trans-contractors.

In greater detail, the trans-contractor app (10), as a mobile device software application, is configured to calculate a cost/hourly rate based on the service of work agreement between Driver/User and contracting entity to determine an estimated cost/hourly rate for the Driver/User acquisition of services. The mobile device accesses the trans-contractor app (10) to calculate a suggested cost/hourly rate based on the service of work agreement between Driver/User and contracting entity, and then suggests a rate that coincides with the Driver/User projected goals and current verified qualifications/experience. This electronic negotiation process compares updated industry averages, and estimates a cost/hourly rate for the Driver/User's services. The trans-contractor app (10) preferably includes built-in programming features, which serve as a risk manager to identify areas of conflict in judgment based on circumstances and personal views.

Additionally, the trans-contractor app (10) includes programming configured to populate an electronic bid packet based on the Driver/User projected financial progression, and electronically submits forms and acceptance agreements to potential contracting organizations. The comparison occurs when the Driver/User has used the trans-contractor app (10) to access an open online contracting opportunity that has been posted to a load board database. The database is preferably pre-populated by the contracting organization's projected terms-of-service outlining suggested salary, benefits, compensation, skill set requirements, classification, and certification requirements. These depictions are automatically checked against the Driver/Users qualifications, classification status, and information report in order to provide the Driver/User with an individualized projected knowledge progression percentage rate for the Driver/User. The driver/user is scored on a scale of 1 to 10, and is awarded the potential knowledge gained from contracting opportunities with the organization. This percentage is then divided by the number of compatibilities between the contracting organization's suggested requirements and the Driver/User information report. Then, these variables are added to the Driver/Users knowledge expansion rate to identify a potential financial growth rate of the Driver/User's potential contracting opportunity.

Additionally, some embodiments of the trans-contractor app (10) of the present invention may be configured to use a built in data capturing system which utilizes updates that are uploaded by the Driver/User relating to contracted assignments and their corresponding results. These updates are systematically compared against accepted contracted load requirements, weather, traffic conditions, and Driver/User functionality and skill set to determine an ETA that has been calculated in days, hours and minutes. The projected ETA is preferably accessible to the Driver/User via the Trans-contractor app (10), as well as to contracting organizations while simultaneously displaying all pickup and delivery locations for continuous contracting agreements. In such implementations of the trans-contractor app (10) and method of the present invention, the User/Driver is screened on trip preparation tactics and ethics. Based on the answers provided by the user/driver to the trans-contractor app (10), the trans-contractor app (10) can identify problem areas, and score the trans-contractor based on the most efficient practices within the commercial transportation industry best practices. The variables are scored based on the relevance to the transportation requirements of the organization in order to determine an individualized Driver/User ETA per contracted agreement.

In other embodiments of the trans-contractor app (10) of the present invention, the trans-contractor app (10) is configured to periodically communicate with an online server computer automatically to populate information acquired from the Driver/User's uploaded information logs, reports, certifications, check lists, and classification(s) in order to identify and gauge the Driver/User operating progression during the course of a contracted service agreement. In short, the trans-contractor app (10) is preferably in communication with an external hardware system configured to monitor and update Driver/User Logs, Certifications, Classification and Records by periodically checking the Driver/User's information against the FMSCA and DOT database to ensure compliance, even throughout a contract assignment. The trans-contractor app (10) may also be configured to activate an internal motion monitoring program triggered by the Driver/User's activation of the Electronic Logging program (which may be interfaced with his/her equipment or downloaded on the mobile device as a separate application) to gauge and track the Driver/User's maneuvering motions and performance handling when accelerating, decelerating, braking, and turning. The mobile device (or device interfaced with the driver/user's equipment) may be configured to capture this information, and transmit the results to an online server computer which pinpoints location status in order to determine and track the Driver/User performance improvements. These updates are systematically compared against load requirements, weather, traffic conditions, and the Driver/User's functionality/competency to communicate best suggested practices designed to improve efficiency, safety and skill-set progression.

In some embodiments of the present invention, the device's suggested programming is initiated when the driver falls 15 minutes behind the pre-scheduled ETA. The online server communicates the affecting negative variables to the device indicating conditions requiring a change in the ETA, which may then be relayed to the contracting organization.

The tracking features of the trans-contractor app (10) is preferably capable of linking to an onboard camera device that can relay current road hazards to other software compatible programs and devices within the area in order to communicate the risk of present road conditions, and raise awareness to the driver/user (graduated trans-contractor) of potential hazards along routes.

Similarly, the mobile device preferably uses an individual Driver/User specific data capturing program to track and maintain registered Driver/User's vehicle operating maneuvers, lane changes, speed, accelerations, deceleration and braking to create an electronic footprint of the driver/user, depicting locations and behavioral patterns among Driver/Users, and to provide transmittable and printable feedback based results.

The data capturing features of the system of the present invention utilizes updates that are uploaded by the Driver/User during use. These updates are systematically linked to the trans-contractor app (10) by opening a online port to an electronic log book (often interfaced with the equipment of the driver/user) with the ability to transmit and print items including:

a) Duty station and location logging

b) Electronic signature

c) Driver logs

e) In cab inspection and data reports

f) Driving time
Breaks taken by the driver/user
Time spent on Duty
Time spent off duty

g) Hours of service availability

In preferred embodiments of the system of the present invention, the mobile device running the trans-contractor app (10) uses a built-in data capturing software program that utilizes updates that are uploaded by the Driver/User as previously described. These updates are collected, processed, categorized and transmitted into a printable format (if needed) that displays:

a) Citation record reports;

b) Federal and state D.O.T changes in regulation and laws;

c) Load or commodity identification and securing techniques;

d) Displays rest stops, truck stops, trucking parking, weight stations, truck friendly restaurants, traffic and weather via a map built-in to the trans-contractor app (10).

In order to accomplish such reports, the trans-contractor app (10) is preferably configured to interface with the on-board GPS module of the mobile device, which facilitates the tracking of the trans-contractor while on a job. Elements tracked and logged via the GPS module preferably include, but are not limited to, the speed at which the driver executes turns, the running speed of the driver when on roads in comparison to the posted speed limit of the road, the stopping rate of the driver in accordance with the type of equipment he/she is driving/operating, duration of stop time (breaks), etc.

It should be understood that in all embodiments of the present invention, the Trans-contractor app (10) is envisioned to function on conventional smartphones, tablets, laptop computers, and other mobile devices. The mobile device running the Trans-contractor app (10) is preferably equipped with a touchscreen and is connected to the internet. Additionally, it should be understood that the trans-contractor app (10) is configured to be a progressive training application for use by a driver (or driver in training) that can later double as a driving companion and assistant after graduation.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A method for educating, training, and certifying commercial truck drivers as Trans-contractors via a mobile device application comprising:
evaluating the past driving experience of the commercial truck driver with a background questionnaire administered by the mobile device application;
conducting a background investigation on the history and records of the commercial truck driver executed by the mobile device application interfaced with one or more background reporting agencies;
evaluating the physical state of the commercial truck driver with physical testing in practice;
evaluating the mental state of the commercial truck driver with a psychological examination;
educating the commercial truck driver in basic marketing tactics for success in the industry via lessons administered by the mobile device application;
evaluating the commercial truck driver on the basic marketing tactics with testing administered by the mobile device application;
educating the commercial truck driver with motivation classes:
educating the commercial truck driver with Commercial Vehicle Enforcement (C.V.E.) training as a practical training portion which is administered by the mobile device application;
educating the commercial truck driver in driver safety and defensive driving techniques via lessons administered by the mobile device application;
simulating contract bidding via the mobile device application;
evaluating the commercial truck driver on the driver safety and defensive driving techniques with testing;
wherein testing is tailored according to the contextual results of the background questionnaire including the experience of the commercial truck driver; and
awarding the commercial truck driver a Trans-contractor certification.

2. The method of claim 1, wherein the commercial truck driver must achieve a passing average score as compiled from the individual scores of each test to progress to a practical training portion of instruction.

3. The method of claim 1, further comprising:
educating the commercial truck driver on the following topics: the demands of the profession, the nature of cabin fever, mental decompression, emotional decompression, and circadian rhythms;
testing the commercial truck driver via the mobile device application on the following topics: the demands of the profession, the nature of cabin fever, mental decompression, emotional decompression, and circadian rhythms; and
permitting the commercial truck driver to advance to the practical testing portion pending a passing test score.

4. The method of claim 1, wherein the background investigation includes the following:
compiling criminal records, commercial records, financial records, pertinent character references, employment history, identity information, address information, contact information, credit history, drug testing history, and education background of each commercial truck driver.

5. The method of claim 1, wherein basic marketing techniques include skills from the following group:
skills in organization, customer relationships management, positioning, consumer behavior comprehension, economic patterns, account management, ethical marketing, relationship marketing, pitch book advertising, online advertising.

6. The method of claim 1, wherein the motivation classes teach the commercial truck driver the following motivational topics selected from the following group:
self-motivation, temporal motivation, achievement motivation, self determination theory, goal setting, models of behavior change, acceptance, curiosity, eating, family, honor, independence, physical activity, saving, vengeance, social contact, tranquility.

7. The method of claim 1, wherein the driver safety and defensive driving education includes education pertaining to topics including:
road awareness, traffic psychology, rules of the road, cargo securing, cargo awareness, and dunnage bag usage.

8. The method of claim 3, wherein the commercial truck driver must achieve a passing average score as compiled from the individual scores of each test to progress to a practical training portion of instruction.

9. The method of claim 3, wherein the background investigation includes elements selected from the following group:
compiling criminal records, commercial records, financial records, pertinent character references, employment history, identity information, address information, contact information, credit history, drug testing history, education background of each commercial truck driver.

10. The method of claim 3, wherein basic marketing techniques taught are selected from the following group:
skills in organization, customer relationships management, positioning, consumer behavior comprehension, economic patterns, account management, ethical marketing, relationship marketing, pitch book advertising, and online advertising

11. The method of claim 4, wherein basic marketing techniques taught are selected from the following group:
skills in organization, customer relationships management, positioning, consumer behavior comprehension, economic patterns, account management, ethical marketing, relationship marketing, pitch book advertising, online advertising.

12. The method of claim 1, further comprising:
monitoring the progress of the candidate as he/she tests in each skill via the mobile device application;
administering the tests to the candidate via the mobile device application; and
simulating contract bidding practices via the mobile device application.

13. A method of connecting trans-contractors to education, evaluation, and contracts comprising:
creating an account for the trans-contractor via a trans-contract mobile device application;
the trans-contractor mobile device application providing training resources to the trans-contractor;
the trans-contractor mobile device application evaluating the trans-contractor according to the training resources provided;
the trans-contractor mobile device application creating a website on behalf of the trans-contractor upon successful evaluation of the trans-contractor;
the trans-contractor mobile device application providing mock bidding sessions through a secured server computer to train the trans-contractor on how to bid on contracts for work; and
the website of the trans-contractor facilitating the creation of a business front for the trans-contractor online.

14. The method of claim 13, further comprising:
the website displaying up-to-date data relating to the proficiency of the trans-contractor on a point scale of one to ten for each type of equipment; and
wherein the proficiency of the trans-contractor is rated on use of specific types of equipment selected from the following group: flat bed trucks, haz-mat trucks, tanker trucks, passenger vehicles.

15. A method of training, evaluating, qualifying, and tracking a commercial driver via a mobile device application comprising:
installing the mobile device application on a mobile device of the commercial driver, the mobile device equipped with internet access, a GPS module, and a touch screen;
the mobile device application administering a background questionnaire to the commercial driver;
the mobile device application administering a knowledge test to the commercial driver according to trucking industry practices;
the mobile device application assessing the knowledge of the commercial driver based on experience entered on the background questionnaire;
the mobile device application creating customized training to educate the commercial driver in content in which the commercial driver has indicated a lack of proficiency on the background questionnaire and knowledge test;
the mobile device application testing the commercial driver on the content of the customized training;
the mobile device application providing the commercial driver access to mock bidding scenarios to enable the commercial driver to practice vying for contracts in accordance with real-world practices of the trucking industry upon the commercial driver achieving a passing score on the test of the content of the customized training;
the mobile device application creating a custom website for the commercial driver;
the mobile device application selecting a custom domain and host server for display of the custom website on the internet;
the mobile device application automatically populating content to the custom website;
wherein the automatically populated content includes the passing score of the test of the content of the customized training;
wherein the automatically populated content includes ratings of the commercial driver's proficiency in driving specific types of equipment selected from the following group: hazmat trucks, flat bed trucks, tanker trucks, passenger vehicles;
the mobile device application tracking the movement of the commercial driver via the GPS during a job awarded through bidding;
wherein the movement tracked includes the stopping speed, acceleration speed, turning speed, speed of driving compared against the posted speed limit, duration of movement, and duration of rest; and
logging the tracked movements so as to be accessible to contracting organizations.
